(19) United States
(12) Patent Application Publication
(10) Pub. No.: US 2025/0282005 A1
(43) Pub. Date: Sep. 11, 2025

(54) JOINING MATERIAL

(71) Applicant: Panasonic Intellectual Property Management Co., Ltd., Osaka (JP)

(72) Inventors: YUMI TAKAO, Hyogo (JP); SHINJI ISHITANI, Hyogo (JP); AKIO FURUSAWA, Osaka (JP); HIROHISA HINO, Osaka (JP)

(21) Appl. No.: 19/215,305

(22) Filed: May 21, 2025

Related U.S. Application Data
(63) Continuation of application No. PCT/JP2023/038737, filed on Oct. 26, 2023.

(30) Foreign Application Priority Data
Dec. 6, 2022 (JP) 2022-194830

(51) Int. Cl. B23K 35/02; B23K 35/26; B23K 35/362

(52) U.S. Cl. CPC B23K 35/0244; B23K 35/262; B23K 35/362

(57) ABSTRACT

A joining material includes single particles made of a first metal as a solder alloy containing Sn, Bi, and In, composite particles each having a first metal particle made of the first metal as a central core and each including a coating layer covering an entire surface of the first metal particle, the coating layer being formed by second metal particles made of a second metal, and a flux including a reducing agent component. The second metal is a component that forms an intermetallic compound with the first metal, a weight percentage of the second metal particles is 30 wt. % to 50 wt. % when a total mass of the single particles and the composite particles is 100 wt. %, the first metal particles have an average particle size of 100 nm to 2000 nm, the second metal particles have an average particle size of 50 nm to 500 nm, a weight percentage of the first metal particles as the central cores of the composite particles is 40 wt. % to 60 wt. % when a total mass of the single particles and the first metal particles as the central cores of the composite particles is 100 wt. %, and the reducing agent component of the flux is present between the central core and the coating layer in the composite particle.

### TECHNICAL FIELD

The present disclosure relates to a joining material for joining two members with a metal material, for use in the field of printable electronics or the like.

### BACKGROUND ART

In devices used in the field of printable electronics or the like, there is a device having a joining structure in which two members of a substrate having an electric circuit using a resin having a film shape as a base material and an electronic component are joined for the purpose of imparting flexibility.

Various resins such as polyethylene terephthalate (PET), polyamide, and polyimide are used as a resin having a film shape intended to have flexibility, and use of a PET film is desired in terms of price.

Since the PET film has a low glass transition temperature, there is a problem that a typical lead-free solder (for example, Sn-3.5Ag-0.5Cu, melting point: 219° C.) cannot withstand the soldering temperature when electronic components are joined to the substrate.

Therefore, when a PET film base material is used, it is necessary to perform joining using a silver paste obtained by adding particulate silver to a thermosetting resin or a lead-free solder having a low melting point as a joining material for an electronic component.

However, in the case of a silver paste, the silver paste is joined through adhesion by curing of a thermosetting resin, and it is necessary to use a silver paste having a low curing temperature when the silver paste is used for a PET film base material having low heat resistance. The melting point is low also in the case of joining by using lead-free solder having a low melting point, and remelting occurs when the temperature rises to the melting point or higher after joining. Therefore, in any case, there is a problem that heat resistance after joining is low.

Therefore, there is a demand for a joining material having characteristics that a temperature at the time of joining is low and heat resistance after joining is excellent.

As one solution to such a problem, a transient-liquid-phase (TLP) joining method by using a joining material containing copper nanoparticles that are nano-sized copper and a solder alloy containing Sn has been proposed. That is, copper nanoparticles as a high melting point metal and solder alloy particles as a low melting point metal are brought into contact with each other to melt the solder alloy particles as the low melting point metal, and thus, an intermetallic compound with the high melting point metal is formed by mutual diffusion between the copper nanoparticles and the solder alloy particles. As a result, a method for shortening a mutual diffusion time by increasing a remelting temperature of a joining portion by a joining temperature, setting a maximum use temperature to be higher than the joining temperature, and using a high melting point metal as nanoparticles has been proposed (see, for example, PTL 1).

### CITATION LIST

### Patent Literature

PTL 1: Unexamined Japanese Patent Publication No. 2020-176331

### SUMMARY OF THE INVENTION

A joining material according to an aspect of the present disclosure includes single particles made of a first metal as a solder alloy containing Sn, Bi, and In, composite particles each having a first metal particle made of the first metal as a central core and each including a coating layer covering an entire surface of the first metal particle, the coating layer being formed by second metal particles made of a second metal, and a flux including a reducing agent component. The second metal is a component that forms an intermetallic compound with the first metal, a weight percentage of the second metal particles is 30 wt. % to 50 wt. % when a total mass of the single particles and the composite particles is 100 wt. %, the first metal particles have an average particle size of 100 nm to 2000 nm, the second metal particles have an average particle size of 50 nm to 500 nm, a weight percentage of the first metal particles as the central cores of the composite particles is 40 wt. % to 60 wt. % when a total mass of the single particles and the first metal particles as the central cores of the composite particles is 100 wt. %, and the reducing agent component of the flux is present between the central core and the coating layer in the composite particle.

### BRIEF DESCRIPTION OF THE DRAWINGS

FIG. 1 is a schematic sectional view illustrating a sectional configuration of a joining material according to a first exemplary embodiment.

FIG. 2 is Table 1 representing components, particle sizes, and weight percentages contained in joining materials, and evaluation results in Examples 1-1 to 1-13 and Comparative Examples 1-1 to 1-6.

FIG. 3 is Table 2 representing conditions of joining materials and evaluation results in Examples 2-1 to 2-10 and Comparative Examples 2-1 to 2-6.

### DESCRIPTION OF EMBODIMENT

### Background Leading to the Present Disclosure

As described above, when nanoparticles of a high melting point metal are used in a joining material for joining a substrate and an electronic component by TLP joining of metal, a surface of a low melting point metal is covered. On the other hand, it is necessary to reduce a content of fine particles. In this case, the entire amount of the low melting point metal cannot form an intermetallic compound, and the low melting point metal remains in a joining portion, and there is a problem that it is difficult to secure heat resistance of the joining portion.

Specifically, nanoparticles such as copper nanoparticles have large surface energy, and adhere to the surface of the low melting point metal when the nanoparticles are mixed with the low melting point metal as the joining material, and are completely encapsulated or covered. Therefore, there is a problem that melting properties of the low melting point metal at the time of heating deteriorates, the reaction does not sufficiently proceed, the low melting point metal remains in a joining layer, and the heat resistance is lowered.

As the joining material for joining the substrate and the electronic component by the TLP joining of the metal, the inventors of the present invention have studied to sufficiently prepare a low melting point metal containing a certain amount of high melting point metal in fine particles and having a surface covered with high melting point metal fine particles, and to provide single low melting point metal particles. That is, the joining material includes composite particles each having a first metal particle made of a first metal as a low melting point metal as a central core and each including a coating layer formed by second metal particles made of a second metal as a high melting point metal covering the entire surface of the first metal particle, and single particles made of the first metal. The joining material including the composite particles and the single particle has been studied.

According to the joining material, since the second metal particles made of the second metal as the high melting point metal are used, a time required for joining can be shortened, and thermal damage to peripheral members at the time of joining can be suppressed. On the other hand, the first metal as the low melting point metal is present as the single particle and the central core of the composite particle, and in particular, the second metal particle made of the second metal covering the central core of the composite particle and the first metal particle of the central core react with each other to form the intermetallic compound. In addition, the single particle becomes a liquid phase by heating to become a parent phase of the composite particle, and contributes to the production of the intermetallic compound. As a result, the intermetallic compound having a high melting point can be obtained, and heat resistance can be obtained.

A joining material layer made of the joining material is heated at a temperature more than or equal to a temperature (hereinafter, referred to as “liquid phase generation temperature”.) at which a liquid phase made of the first metal is generated even in part to form the liquid phase made of the first metal, and the first metal and the second metal in the composite particles are reacted to generate the intermetallic compound. At this time, the joining layer in which the composite particles are connected to each other by the intermetallic compound generated by reacting the first metal contained in the single particle with the second metal on the surface of the composite particle is formed. As a result, the inventors of the present invention have found that the substrate and the electronic component can be joined by the joining layer having high joining strength and heat resistance, and have completed the present disclosure.

The present disclosure solves the problems of related art, and an object of the present disclosure is to provide a joining material excellent in heat resistance.

A joining material according to a first aspect includes single particles made of a first metal as a solder alloy containing Sn, Bi, and In, composite particles each having a first metal particle made of the first metal as a central core and each including a coating layer covering an entire surface of the first metal particle, the coating layer being formed by second metal particles made of a second metal, and a flux including a reducing agent component. The second metal is a component that forms an intermetallic compound with the first metal, a weight percentage of the second metal particles is 30 wt. % to 50 wt. % when a total mass of the single particles and the composite particles is 100 wt. %, the first metal particles have an average particle size of 100 nm to 2000 nm, the second metal particles have an average particle size of 50 nm to 500 nm, a weight percentage of the first metal particles as the central cores of the composite particles is 40 wt. % to 60 wt. % when a total mass of the single particles and the first metal particles as the central cores of the composite particles is 100 wt. %, and the reducing agent component of the flux is present between the central core and the coating layer in the composite particle.

In a joining material according to a second aspect, in the first aspect, the second metal may be Cu.

In a joining material according to a third aspect, in the first or second aspect, a composition of the first metal may be a composition corresponding to a content at which a liquidus temperature is less than or equal to 100° C. in an equilibrium state diagram of a Sn—Bi —In alloy.

In a joining material according to a fourth aspect, in any one aspect of the first to third aspects, a composition of the first metal may be Sn-55 wt. % Bi-20 wt. % In.

In a joining material according to a fifth aspect, in any one of the first to fourth aspects, when a total mass of the single particles and the composite particles is 100 wt. %, a weight percentage of the second metal particles may be 37.5 wt. % to 50 wt. %.

In a joining material according to a sixth aspect, in any one of the first to fifth aspects, when a total mass of the single particles and the composite particles is 100 wt. %, a weight percentage of the second metal particles may be 40 wt. % to 50 wt. %.

In a joining material according to a seventh aspect, in any one of the first to sixth aspects, the reducing agent component may be an alkanolamine.

Note that, in the present specification, the expression “A-xwt. % B (A and B are metal elements, and x is a percentage value)” is used to describe the composition of the alloy. This means that the alloy includes the metal elements A and B, the metal element B is x wt. % (mass %) and the remainder is wt. % (=100−x) of the metal element A.

As described above, in accordance with the joining material according to the present disclosure, the joining material containing the single particles and the composite particles, and thus, it is possible to prevent deterioration of meltability at the time of heating and to obtain the joining portion excellent in the heat resistance.

Hereinafter, a joining material and a joining structure according to an exemplary embodiment of the present disclosure will be described in detail with reference to the accompanying drawings.

### First Exemplary Embodiment

### <Joining Material>

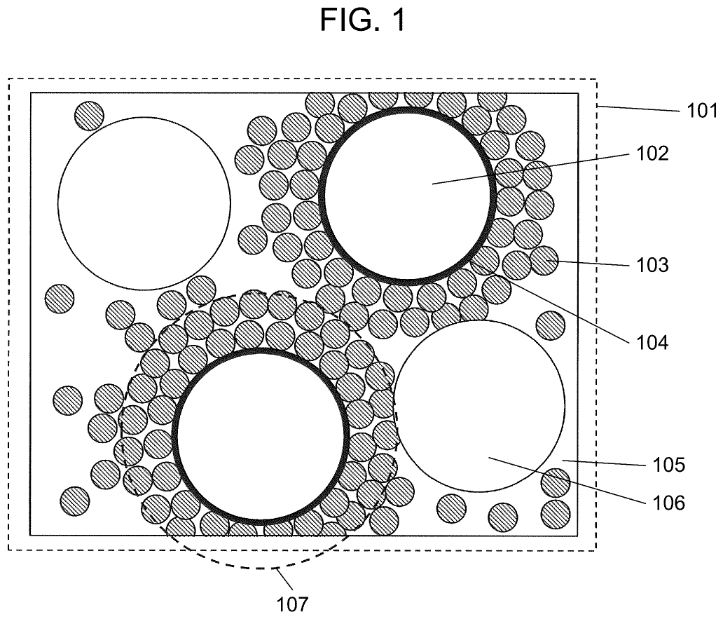

FIG. 1 is a schematic sectional view illustrating a sectional configuration of joining material 101 according to a first exemplary embodiment.

Joining material 101 according to the first exemplary embodiment of the present disclosure includes single particles 106 made of a first metal as a solder alloy containing Sn, Bi, In, and other inevitable components, composite particles 107 using a first metal particle made of the first metal as a central core and including a coating layer formed by second metal particles covering the entire surface of the first metal particle and made of a second metal, and flux 105 having a reducing agent component. In joining material 101, the first metal and the second metal can form an intermetallic compound. In addition, reducing agent 104 of flux 105 is present between the central core and the coating layer in composite particles 107. In this joining material, the heat resistance of the joining portion is improved by using single particles 106 and composite particles 107.

Hereinafter, constituent members used for joining material 101 will be described.

### <Single Particle, First Metal Particle>

Single particle 106 made of the first metal and first metal particle 102 made of the first metal that becomes the central core (core) of composite particles 107 will be described. The first metal constituting single particle 106 and first metal particle 102 used in the present disclosure contain Sn, Bi, In, and other inevitable components. This first metal has a low liquid phase generation temperature. As a result, before second metal particles 103 constituting the coating layer (shell) of composite particle 107 are sintered, a liquid phase is formed by single particle 106 and first metal particle 102 as the central core of composite particle 107, and a strong joining interface is formed by wetting or chemical reaction with a joined member. At the same time, liquid phase diffusion occurs between the liquid phase and second metal particles 103, and thus, an intermetallic compound can be formed. As a result, a joining layer having excellent heat resistance is formed. In addition, at the time of joining with the joining material, a joining portion is formed between the joining material and the joined portion by heating the joining material at a temperature more than or equal to the liquid phase generation temperature of single particle 106 and first metal particle 102 as the central core of composite particle 107. In addition, since the heating temperature at the time of being joined to the joined portion needs to be equal to a temperature of low-temperature solder in the related art, the liquid phase generation temperature is preferably less than or equal to 100° C. (liquid phase generation temperature≤100° C.). A composition of such an alloy is not particularly limited as long as such an alloy has a composition in which the liquid phase generation temperature (liquidus temperature) is less than or equal to 100° C., but preferably has a composition in which the liquid phase generation temperature (liquidus temperature) becomes less, and for example, particularly preferably Sn-55 wt. % Bi-20 wt. % In.

An average particle size of first metal particles 102 is preferably 100 nm to 2000 nm. As a result, the first metal particle has a large specific surface area and a particle size close to a particle size of second metal particle 103, and thus, it is possible to form the intermetallic compound in a short time and to prevent generation of voids during the reaction between the liquid phase and a solid phase.

Note that the average particle size is calculated by using a laser particle size distribution meter. The average particle size is a value of a median diameter D50% (μm, in terms of volume). The same applies hereinafter.

When a total mass of single particles 106 and first metal particles 102 as the central cores (cores) of composite particles 107 is 100 wt. %, a proportion of single particles 106 is preferably 30 wt. % to 60 wt. %. When the proportion of single particles 106 exceeds 60 wt. %, second metal particles 103 constituting the coating layers (shells) of composite particles 107 become excessive, and a plurality of layers are formed. When the joining material is heated, since the layer of second metal particle 103 becomes the intermetallic compound and first metal particle 102 as the central core of composite particle 107 remains without wetting and spreading, the heat resistance tends to decrease. In addition, when the proportion of single particles 106 is less than 30 wt. %, since composite particles 107 cannot be joined together, the strength of the joining portion tends to decrease.

### <Second Metal Particle>

The second metal constituting second metal particles 103 of the coating layer (shell) of composite particle 107 has a melting point higher than a melting point of the first metal, and is preferably a metal capable of forming the intermetallic compound with Sn and In contained in the first metal, and particularly preferably Cu. An average particle size of second metal particles 103 is preferably 50 nm to 500 nm. When the average particle size of second metal particles 103 exceeds the above upper limit, a contact area with first metal particle 102 tends to be small, and a time required for joining tends to be long. In addition, the lower limit of the average particle size of second metal particles 103 is preferably more than or equal to 50 nm from the viewpoint of retaining characteristics as the metal.

When the total mass of single particles 106 and composite particles 107 is 100 wt. %, a proportion of second metal particles 103 is preferably 30 wt. % to 50 wt. %. When a content of second metal particles 103 is less than the lower limit, the formation of the intermetallic compound by the liquid phase diffusion reaction between melted Sn and In and second metal particles 103 becomes insufficient, and Sn and In that cannot form the intermetallic compound remain in the joining layer, and the heat resistance of the joining layer tends to decrease. In addition, when the content of second metal particles 103 exceeds the upper limit, the residual amount of second metal particles 103 that cannot form the intermetallic compound in the joining layer is excessive, and the strength of the joining layer tends to decrease.

### <Flux>

For example, alkanolamines are preferable as reducing agent 104 component of flux 105 present between the central core (core) and the coating layer (shell) in composite particle 107. The alkanolamines coat the surface of first metal particle 102 as the central core of composite particle 107, and second metal particles 103 adheres to the coating layer. As a result, a strong bond can be formed.

### EXAMPLES

The present disclosure will be described in more detail based on examples, but the present disclosure is not limited to the examples.

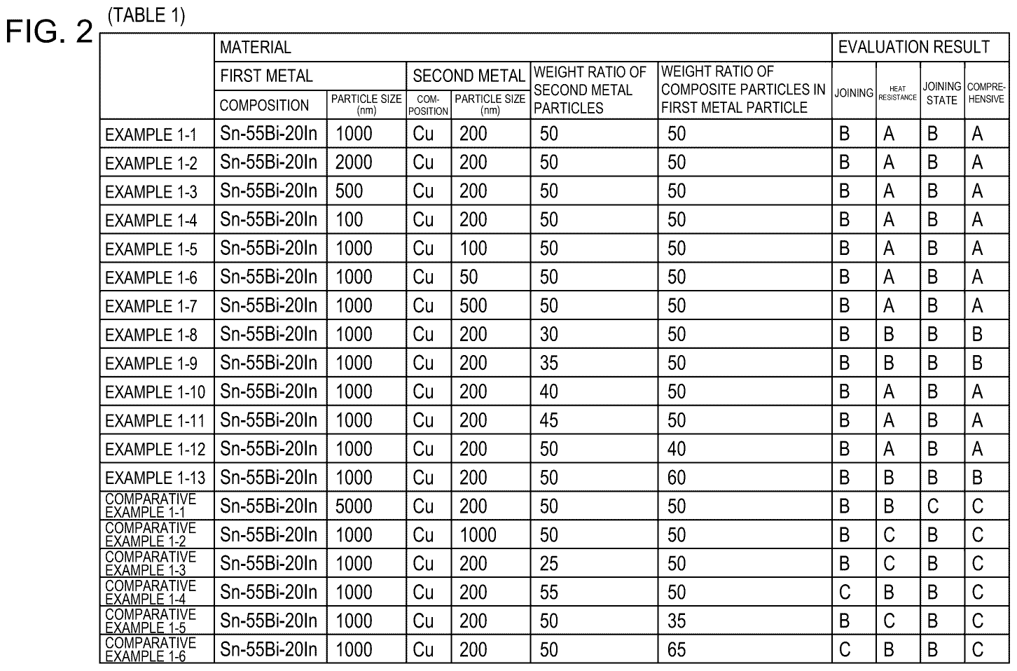

To confirm effects of the present first exemplary embodiment, joining material 101 in which particle sizes and mixing ratio of first metal particles 102 and second metal particles 103 are changed are produced as Examples 1-1 to 1-11 and Comparative Examples 1-1 to 1-4. Components contained in joining material 101 and weight percentages thereof, the particle sizes of first metal particles 102 and second metal particles 103, weight percentages of composite particles 107 and single particles 106 in first metal particles 102, and evaluation results in Examples 1-1 to 1-11 and Comparative Examples 1-1 to 1-4 are represented in Table 1 of FIG. 2. The particle sizes of first metal particles 102 and second metal particles 103 represented in Table 1 are both median diameter D50.

### <Joining Material 101>

As first metal particle 102 in the present first exemplary embodiment, Sn-55 wt. % Bi-20 wt. % In is evaluated. In addition, Cu nanoparticles are evaluated as second metal particles 103.

In a method for manufacturing joining material 101, first, 50 mass % of entire first metal particles 102 and triethanolamine are mixed, the surface of first metal particle 102 is coated with reducing agent 104, and then the first metal particles are mixed with second metal particles 103 to obtain composite particles 107. Obtained composite particles 107 are kneaded with single particles 106 as the remainder of first metal particles 102 and flux 105 to obtain joining material 101 paste.

### <Joining Process>

A Joining structure is produced to confirm the effects of the present first exemplary embodiment. The joining process is as follows.

First, joining is performed by using produced joining material 101.
(a) Joining material 101 is supplied onto a Cu plate by using a metal mask having a thickness of 100 μm and an opening of 1 mm×1 mm.
(b) A Si element is mounted on supplied joining material 101. An electrode of the Si element joined to joining material 101 is formed by plating of Ti/Ni/Au from the Si side.
(c) A load of 1 MPa is applied from above the mounted Si element, and heating is performed at 100° C. for 10 minutes in an N₂ atmosphere to produce the joining structure in which the electrode of the Si element and the Cu plate are joined to joining material 101.

### <Joining Evaluation>

After performing a series of joining processes, whether or not the Cu plate and the electrode of the Si element are joined is confirmed. In Table 1, it is determined as “B” in a case where the Cu plate and the electrode of the Si element are joined, and it is determined as “C” in a case where the Cu plate and the electrode of the Si element are not joined.

### <Heat Resistance Evaluation>

Next, heat resistance after joining is evaluated. Joining material 101 is taken out from the produced joining structure, and evaluation of TG/DTA is performed. In the TG/DTA, it is determined as “B” in a case where there is no endothermic behavior at a temperature lower than a melting point (232° C.) of Sn, in particular, it is determined as “A” in a case where there is no endothermic behavior at a temperature lower than a melting point (271° C.) of Bi, and it is determined as “C” in a case where an endothermic behavior is observed at a temperature lower than a melting point of Sn.

### <Joining State Evaluation>

Further, a joining state of the joining structure is evaluated through sectional observation. The produced joining structure is observed with an electron microscope (SEM), and it is determined as “B” in a case where an abnormality is not observed in the formed intermetallic compound, and it is determined as “C” in a case where a significant void is present inside the intermetallic compound.

### <Comprehensive Evaluation>

In a case where there is no “C” in all the items of the above evaluation, it is determined as “B” (good), and in such a case, in particular, in a case where the heat resistance is “A”, it is determined as “A” (excellent), and in a case where there is at least one item of “C”, it is determined as “C” (bad).

As represented in Table 1 of FIG. 2, among Examples 1-1 to 1-13, in Examples 1-1 to 1-7 and 1-10 to 1-12, the joining is “B”, the heat resistance is “A”, and the joining state is “B”, and in Examples 1-8, 1-9, and 1-13, the joining, the heat resistance, and the joining state are “B”, and all the examples exceed evaluation criteria.

In these Examples, the particle size of first metal particle 102 is 100 nm to 2000 nm in comparison between Examples 1-1 to 1-4. The particle size of second metal particle 103 is 50 nm to 500 nm in comparison between Examples 1-1, 1-5, and 1-7. In addition, the heat resistance is “A” in a case where the weight percentage of second metal particles 103 is 40 wt. % to 50 wt. %, and the heat resistance is “B” in a case where the weight percentage of the second metal particles is 30 wt. % to 35 wt. % in comparison between Examples 1-1 and 1-8 to 1-11. Further, the heat resistance is “A” in a case where the weight percentage of composite particles 107 is 40 wt. % to 50 wt. %, and the heat resistance is “B” in a case where the weight percentage of the composite particles is 60 wt. % in comparison between Examples 1-1, 1-12, and 1-13.

On the other hand, in Comparative Example 1-1, as a result of sectional observation after joining, a void of several μm is observed in the formed intermetallic compound, and the joining state evaluation is “C”. This phenomenon has not completely elucidated, but it is considered as follows. It is considered that since the particle size of first metal particle 102 used in Comparative Example 1-1 is 5000 nm and is larger than the particle size of second metal particle 103, the intermetallic compound is generated at a surface layer of first metal particle 102, and in first metal particle 102, the reaction of generating the intermetallic compound does not occur instantaneously, but the intermetallic compound is generated by element diffusion via the intermetallic compound at the surface layer.

In Comparative Examples 1-2, 1-3, and 1-5, the heat resistance evaluation is “C”. This is because the first metal remains in any case. In Comparative Example 1-2, it is considered that this is because the particle size of second metal particle 103 is large and the inside of second metal particles 103 is not sufficiently reacted after joining. In addition, in Comparative Example 1-3, it is considered that this is because the weight percentage of second metal particles 103 is as small as 25 wt. %.

When a change in solidus temperature depending on the weight percentage of Sn-55 wt. % Bi-20 wt. % In and Cu is analyzed in a calculation equilibrium state diagram (Thermo-calc), it can be confirmed that the temperature is less than or equal to 100° C. in a case where the weight percentage of Cu as the second metal is less than or equal to 25 wt. %, the temperature is around 232° C. which is the melting point of Sn in a case where the weight percentage is 30 wt. % to 37.5 wt. %, and the temperature is around 271° C. which is the melting point of Bi in a case where the weight percentage is more than or equal to 40 wt. %, and these temperatures coincide with the above results.

In Comparative Example 1-5, the weight percentage of composite particles 107 in first metal particle 102 is as small as 35 wt. %, the second metal fine particles constituting composite particles 107 are excessive, and the layer of second metal particle 103 became an intermetallic compound when heated, so that first metal particle 102 in the central core of composite particles 107 remained without wetting and spreading, and therefore heat resistance is considered to be reduced.

On the other hand, in Comparative Examples 1-4 and 1-6, the joining evaluation is “C”. In addition, it is considered that since the weight percentage of second metal particles 103 is as large as 55 wt. % in the case of Comparative Example 1-4, and the weight percentage of single particles 106 in first metal particles 102 is as small as 35 wt. % in the case of Comparative Example 1-6, first metal particles 102 do not sufficiently wet and spread when the first metal particles are melted, and network formation of the intermetallic compound is insufficient.

From the results of the present first exemplary embodiment, the following is confirmed.

To exhibit the effects of the present disclosure, first, the particle size of first metal particle 102 needs to be 100 nm to 2000 nm.

Next, the particle size of second metal particle 103 needs to be 50 nm to 500 nm.

Next, it is necessary that the weight percentage of second metal particles 103 is 30 wt. % to 50 wt. %, and is particularly desirably 40 wt. % to 50 wt. %. This means that the weight percentage between first metal particles 102 and second metal particles 103 is a ratio at which all Sn and In contained in the solder alloy become the intermetallic compounds with second metal particles 103 in the equilibrium state diagram.

Further, the weight percentage of composite particles 107 in first metal particles 102 needs to be 40 wt. % to 60 wt. %.

In joining material 101 satisfying these conditions, it is possible to provide joining material 101 capable of forming the joining portion having high heat resistance at a low temperature of 100° C. for a short time of 10 minutes.

### Second Exemplary Embodiment

As a second exemplary embodiment, the influence of a metal composition of first metal particle 102 is evaluated.

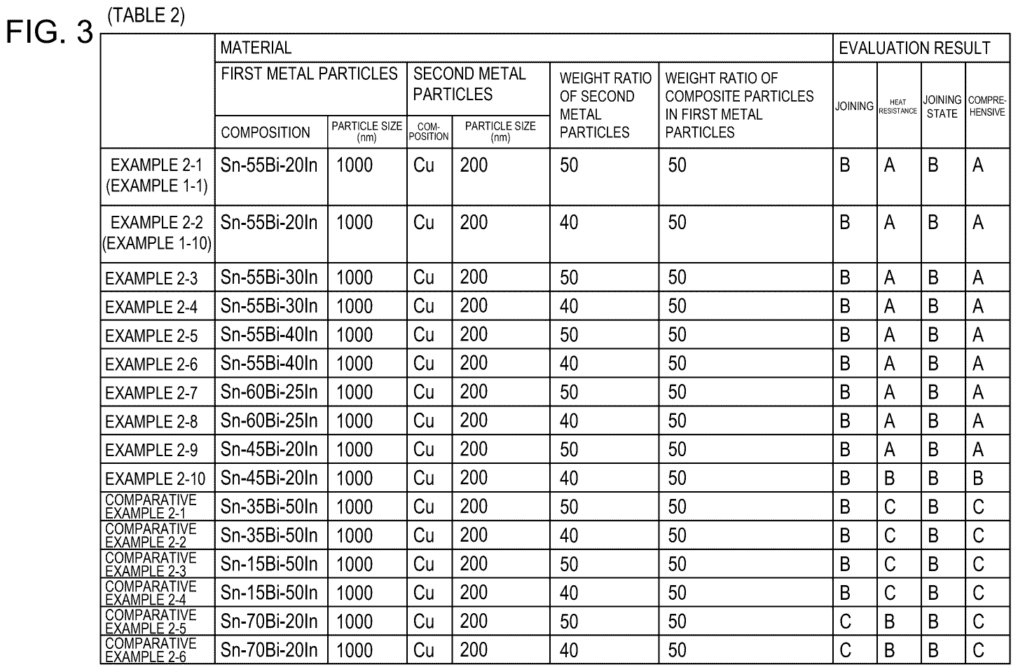

To confirm effects of the present second exemplary embodiment, joining material 101 in which a metal composition of the first metal and a mixing ratio between first metal particles 102 and second metal particles 103 are changed is produced as Examples 2-1 to 2-10 and Comparative Examples 2-1 to 2-6. Conditions and evaluation results of joining material 101 in Examples 2-1 to 2-10 and Comparative Examples 2-1 to 2-6 are represented in Table 2 of FIG. 3.

A method for producing joining material 101, a joining process, and an evaluation method are the same as the first exemplary embodiment.

From Table 2 of FIG. 3, focusing on the metal composition of the first metal, in Examples 2-1 to 2-8 in which the Bi ratio is 55 wt. % to 60 wt. %, the joining state and the heat resistance are “B” and “A”, respectively. In addition, in Examples 2-9 and 2-10 in which the Bi ratio is 45 wt. %, the joining state is “B” and the heat resistance is “A” in a case where the weight percentage of second metal particles 103 is as large as 50 wt. %, and all the evaluations are “B” in a case where the weight percentage of the second metal particles is as small as 40 wt. %, and all the examples exceeded the evaluation criteria.

On the other hand, in the case of Comparative Examples 2-1 to 2-4 in which the Bi ratios are as small as 15 wt. % and 35 wt. %, the heat resistance is “C”. This is considered to be because the ratios of Sn and In as the first metal, which are components forming the intermetallic compound with Cu of the second metal, is large, thus a large amount of Cu is required to completely form the intermetallic compound, and second metal particles 103 are insufficient.

In addition, in Comparative Examples 2-5 and 2-6 in which the Bi ratio is as high as 70 wt. %, the joining is “C”. This is considered to be because the liquidus temperature increases as the Bi ratio increases, and thus the joining material does not sufficiently melt at 100° C.

From the results of the present second exemplary embodiment, the following is confirmed.

The composition of the first metal needs to have a Bi ratio of 45 wt. % to 60 wt. %, and the ratio is particularly preferably 55 wt. % to 60 wt. %. In particular, Sn-55 wt. % Bi-20 wt. % In, which has a wide range of allowable weight percentages of the second metal and has a low content proportion of In of high cost, is most preferable.

In joining material 101 satisfying these conditions, it is possible to provide joining material 101 capable of forming the joining portion having high joining strength.

Note that the present disclosure includes an appropriate combination of any exemplary embodiment and/or example among the various above-described exemplary embodiments and/or examples, and effects of each of the exemplary embodiments and/or examples can be achieved.

### INDUSTRIAL APPLICABILITY

In accordance with the joining material according to the present disclosure, it is possible to provide a joining material and a joining structure capable of exhibiting high heat resistance with heating at a low temperature for a short time, and it is possible to use a resin having low heat resistance as a base material in printable electronics and the like.

### REFERENCE MARKS IN THE DRAWINGS

101 joining material
102 first metal particle
103 second metal particle
104 reducing agent
105 flux
106 single particle
107 composite particle

1. A joining material comprising:
single particles made of a first metal as a solder alloy containing Sn, Bi, and In;
composite particles each having a first metal particle made of the first metal as a central core and each including a coating layer covering an entire surface of the first metal particle, the coating layer being formed by second metal particles made of a second metal; and
a flux including a reducing agent component,
wherein the second metal is a component that forms an intermetallic compound with the first metal,
a weight percentage of the second metal particles is 30 wt. % to 50 wt. % when a total mass of the single particles and the composite particles is 100 wt. %,
the first metal particles have an average particle size of 100 nm to 2000 nm,
the second metal particles have an average particle size of 50 nm to 500 nm,
a weight percentage of the first metal particles as the central cores of the composite particles is 40 wt. % to 60 wt. % when a total mass of the single particles and the first metal particles as the central cores of the composite particles is 100 wt. %, and
the reducing agent component of the flux is present between the central core and covering the coating layer in the composite particle.

2. The joining material according to claim 1, wherein the second metal is Cu.

3. The joining material according to claim 1, wherein a composition of the first metal is a composition corresponding to a content at which a liquidus temperature is less than or equal to 100° C. in an equilibrium state diagram of a Sn—Bi—In alloy.

4. The joining material according to claim 1, wherein a composition of the first metal is Sn-55 wt. % Bi-20 wt. % In.

5. The joining material according to claim 1, wherein, when a total mass of the single particles and the composite particles is 100 wt. %, a weight percentage of the second metal particles is 37.5 wt. % to 50 wt. %.

6. The joining material according to claim 1, wherein, when a total mass of the single particles and the composite particles is 100 wt. %, a weight percentage of the second metal particles is 40 wt. % to 50 wt. %.

7. The joining material according to claim 1, wherein the reducing agent component is an alkanolamine.
